(19) United States
(12) Patent Application Publication
(10) Pub. No.: US 2019/0073538 A1
(43) Pub. Date: Mar. 7, 2019

(54) METHOD AND SYSTEM FOR CLASSIFYING OBJECTS FROM A STREAM OF IMAGES

(71) Applicant: AGENT VIDEO INTELLIGENCE LTD., Rosh HaAyin (IL)

(72) Inventor: Zvi ASHANI, Ganey Tikva (IL)

(21) Appl. No.: 15/765,532

(22) PCT Filed: Sep. 6, 2016
(86) PCT No.: PCT/IL16/50983

§ 371 Date: Apr. 3, 2018

(30) Foreign Application Priority Data
Oct. 6, 2015 (IL) 241863

(51) Int. Cl. G06K 9/00; G06K 9/62; G06F 17/30; G06F 15/18

(52) U.S. Cl. CPC G06K 9/00744; G06K 9/6263; G06F 15/18; G06K 9/6256; G06F 17/3028

(57) ABSTRACT

A computer-implemented method and a corresponding system for classifying objects from a stream of images are presented. The method comprises: providing input data comprising data indicative of at least one image stream; processing said input data and extracting from said at least one image stream a plurality of foreground objects; classifying said plurality of objects, said classifying comprising associating at least some of said plurality of objects in accordance with at least one object type, thereby generating at least one group of objects of similar object types; and generating a training database comprising a plurality of data pieces/records, each data piece comprising image data of one of said plurality of foreground objects and a corresponding objects type. The training database is typically configured for use in training of a learning machine system.

### TECHNOLOGICAL FIELD

The present invention is in the field of machine learning and is generally related to preparation and learning based on training data-base including image data.

### BACKGROUND

Machine learning systems provide complex analysis based on identifying repeating patterns. The technique is based on algorithms configured to recognize patterns and construct a model enabling the machine (e.g. computer system) to perform complex analysis and identification of data. Generally machine learning systems are used for analysis based on patterns where explicit algorithms cannot be programmed or are very complex to program, while the analysis can be done based on understanding of data distribution/behavior. Various machine learning techniques and systems have been developed for different applications requiring analysis based on pattern recognition. Such applications include pattern recognition (e.g. face recognition, image recognition) and additional application.

Learning machine systems generally undergo a training process, being supervised or unsupervised training, to provide the system with sufficient information and enable it to perform the desired task(s). The training process is typically based on pre-labeled data allowing the learning machine system to locate patterns, behavior (e.g. in the form of statistical data) of the labeled data and provide the system with model, set of rules or connections, or statistical variations of parameters enabling the system to perform the desired tasks.

### GENERAL DESCRIPTION

Generation or aggregation of a learning data set, suitable for training a learning machine for one or more tasks, generally requires manual collection of suitable data pieces. The training data set must be appropriately labeled to enable the learning machine system to generate connections between features of the data/object and its label. Generally, a training data set requires a large collection of labeled data and may include thousands to tens or hundreds of thousands of labeled data pieces.

The present invention provides a technique, suitable to be implemented in a computerized system, for generating a training data set. In this connection it should be noted that the technique of the invention is generally suitable for data set for image classification training. However the underlying features and the Inventors' understanding of the process may be utilized for other data types as the case may be.

In the field of image recognition/classification there is an additional challenge in identifying data pieces that relates to distinguishing between background of the image and the actual object being classified, i.e. foreground object. This challenge may be difficult to overcome in analysis based on a single (still) image, while is simple to solve in the case of object extraction from a sequence of time separated images allowing detection of motion. In this connection, the technique of the present invention enables generation of the training data set, while removing data associated with the background and maintaining data associated with foreground objects in the data pieces.

More specifically, the technique of the present invention is based on extraction of data associated with foreground objects from an input image stream (e.g. video data); analyzing the extracted objects and classifying them as belonging to one or more object types; and aggregation of a plurality of classified data pieces associated with the extracted objects into a labeled training data set.

Thus, the technique of the present invention comprises providing an input data indicative of one or more segments of image stream of one or more scenes. The input data is processed based on one or more object extraction techniques such as foreground/background segmentation, movement/shift detection, edge detection, gradient analysis etc., to extract a plurality of data pieces associated with foreground objects detected in the input data.

Each of the plurality of extracted objects, or at least a selected sub set thereof, is classified as belonging to one or more object types in accordance with one or more parameters. The classification may be based on data associated with the input data such as, velocity, acceleration, color, shape, location etc. Additionally or alternatively, the classification may be performed based on any other classification technique such as the use of an already trained learning machine. For Example, the technique may utilize object classification by model fitting as described in, e.g., U.S. published Patent application number 2014/0028842 assigned to the assignee of the present invention. The classified objects are then aggregated to a set of predetermined groups of objects, such that objects of the same group belong to a similar class. Thus the technique provides a set of labeled data pieces that is suitable for use in training of machine learning systems.

Thus, according to a broad aspect of the invention, there is provided a computer-implemented method of classifying objects from a stream of images, comprising:

providing input data comprising data indicative of at least one image stream;

processing said input data and extracting from said at least one image stream a plurality of foreground objects;

classifying said plurality of objects, said classifying comprising associating at least some of said plurality of objects in accordance with at least one object type, thereby generating at least one group of objects of similar object types;

generating a training database comprising a plurality of data pieces/records, each data piece comprising image data of one of said plurality of foreground objects and a corresponding objects type, said training database being configured for use in training of a learning machine system.

The classifying may comprise: providing a selected foreground object extracted from said at least one image stream and processing said selected object to determine a corresponding object type, said processing comprises determining at least one appearance property of the object from at least one image of said stream and at least one temporal property of the object from at least two images of said stream. In this connection, an operator inspection may be used to verify accuracy of the classification, either regularly or on randomly selected samples. The manual checkup may generally be used to improve classification process and quality of classification.

The at least one appearance property of the object may comprise at least one of the following: size, geometrical shape, aspect ratio, color variance and location. The appearance properties may be determined in accordance with dedicated process and use and may include a selection of certain threshold and parameters defining the properties.

The at least one temporal property may comprise at least one of the following: speed, acceleration, direction of propagation, linearity of propagation path and inter-objects interactions. Such temporal properties may generally be determined based on two or more temporally separated appearances of the same object. Generally the technique may use additional appearances of the object to improve temporal properties accuracy.

According to some embodiment, said extracting from said at least one image stream a plurality of foreground objects may comprise determining within corresponding image data of said at least one image stream a group of connected pixels associated with a foreground object and separated at least partially from surrounding pixels associated with background of said image data. To thus end the term surrounding relates to pixels interfacing with certain object along at least one edge thereof while not necessarily along all edges thereof. Generally two or more foreground objects may interface each other in the image stream and may be distinguished from each other based on appearance and/or temporal properties difference between them.

In some embodiments, generating a training database may comprise dedicating a group of memory storage sections, each associated with an identified objects type and storing data pieces of said plurality of classified foreground objects in memory storage sections corresponding to the assigned object types thereof.

According to some embodiments, the data pieces being processed/classified may comprise image data of one of said plurality of foreground objects are characterized as consisting of pixel data corresponding to detected foreground pixels while not including pixel data corresponding to background of said image data.

According to some embodiment, the method may further comprise verifying said classifying of data pieces, e g manual verifying by a user, to ensure quality of classification. The checkup results may be used in a feedback loop to assist in classifying of additional data pieces.

According to one other broad aspect of the invention, there is provided a method of classifying one or more objects extracted from image stream, the method comprising:

providing a training data set, the training data set comprising a plurality of classified objects, each classified objects consists of pixel data corresponding to foreground of said image stream;

training a learning machine system based on said data set to statistically identify foreground objects as relating to one or more objects types;

providing an image stream comprising data about one or more foreground objects, extracting at least one of said one or more foreground objects to be classified from said training, said at least one foreground objects to be classified consists of image data corresponding to foreground related pixels; and

classifying said at least one foreground objects using said learning machine system in accordance with said training data set.

Said providing of a training data set may comprise utilizing the above described method for generating a training data set.

According to some embodiments, the method may comprise inspecting the training data set by a user before the training of the learning machine system, identifying misclassified objects, and correcting classification of said misclassified objects or removing them from said training set.

According to yet another broad aspect, the invention provides a system comprising: at least one storage unit, input and output modules and at least one processing unit, said at least one processing unit comprising a training data generating module configured and operable for receiving data about at least one image stream and generating at least one training data set comprising a plurality of classified objects, each of said classified objects consisting of image data corresponding to foreground related pixel data.

The training data generating module may comprise:

foreground objects' extraction modules configured and operable for processing input data comprising at least one image stream for extracting a plurality of data pieces corresponding to a plurality of foreground objects of said at least one image stream, each of said data pieces consist of pixel data corresponding to foreground related pixels;

object classifying module configured and operable for processing at least one of said plurality of data pieces to thereby determine at least one of appearance and temporal properties of the corresponding foreground object to thereby classify said foreground objects as relating to at least one object type; and

data set arranging module configured and operable for receiving a plurality of classified data pieces and for dedicating memory storage sections in accordance with the corresponding object types and storing said data pieces accordingly to thereby generate a classified data set for training of a learning machine.

According to some embodiments, said object classifying module may further comprise an appearance properties detection module configured and operable for receiving image data corresponding to an extracted foreground object and determining at least one appearance property thereof, said at least one appearance property comprises at least one of: size, geometrical shape, aspect ratio, color variance and location.

Additionally or alternatively, said object classifying module may further comprise a cross image detection module configured and operable for receiving image data associated with data about a foreground object extracted from at least two time separated frames, and determining accordingly at least one temporal property of said extracted foreground object, said at least one cross image property comprises at least one of the following: speed, acceleration, direction of propagation, linearity of propagation path and inter-objects interactions.

In some embodiments the processing unit may further comprise a learning machine module configure for receiving a training data set from said training data generating module and for training to identify input data in accordance with said training data set.

The learning machine module may be further configured and operable for receiving input data and for classifying said input data as belonging to at least one data type in accordance with said training of the learning machine module.

Generally according to some embodiment, the input data may comprise data about at least one foreground object extracted from at least one image stream. Such data about at least one foreground object may preferably be consisting of data about foreground related pixel data. More specifically, the data about certain foreground object may include data about object related pixels while not include data about neighbouring pixels relating to background and/or other objects.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates in a way of a block diagram the technique of the present invention;

FIG. 2 illustrates a technique for classifying objects according to some embodiments of the present invention;

FIG. 3 shows in a way of a block diagram a method for object extraction and classification according to some embodiments of the present invention;

FIG. 4 shown is a way of a block diagram a method for operating a learning machine to train and identify objects from input image stream according to some embodiments of the present invention;

FIG. 5 schematically illustrates a system for generating training data set and learning according to some embodiments of the present invention; and

FIG. 6 shows schematically an object classification module and operational modules thereof according to some embodiments of the present invention.

### DETAILED DESCRIPTION OF EMBODIMENTS

As indicated above, the present invention provides a technique for use in generating a training data set for learning machine. Additionally, the technique of the present invention provides a system, possibly including a learning machine sub-system, configured for extracting labeled data set from input image stream. In some configurations as described further below, the system may also be operable to undergo training based on such labeled data set and be used for identifying specific objects or events in input data such as one or more image streams.

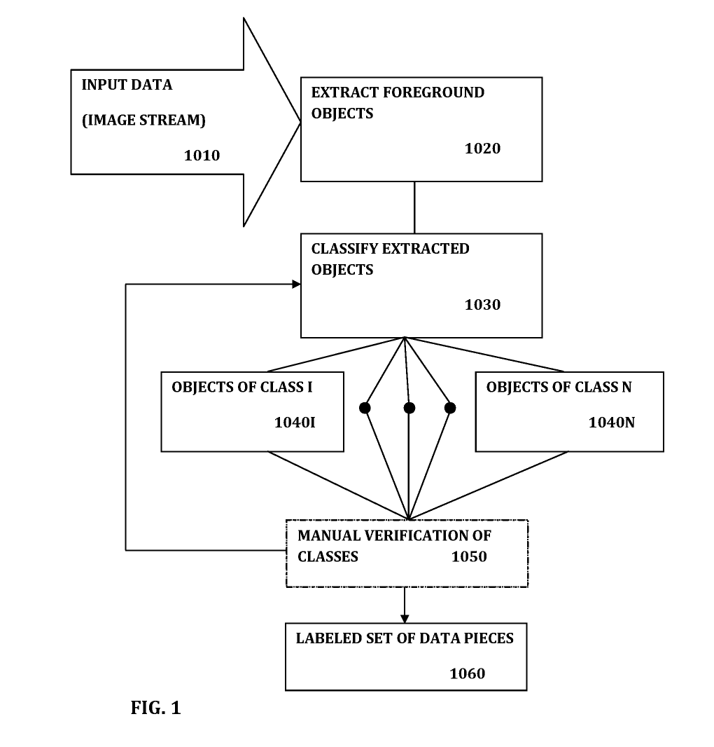

In this connection, reference is made to FIG. 1 schematically illustrating a method according to the present invention. Generally, the technique is configured to be performed as a computer implemented method that is run by a computer system having at least one processing unit, storage unit (e.g. RAM type storage) etc. The method includes providing input data 1010, which is generally associated with image stream (e.g. video) taken from one or more scenes or regions of interests by one or more camera units either in real time or retrieved from storage. In this connection the input data may be digital representation of the image stream in any known format.

The input data 1010 is processed 1020 to extract one or more objects appearing in the captured scene. More specifically, the input image stream may be processed to identify shapes and structures appearing in one or more, preferably consecutive, images and determine if certain shapes and structures correspond to reference background of the images or to an object appearing in the images. Typically, the definition of background pattern or foreground objects may be flexible and determined in accordance with desired functionality of the system. Thus, in a system configured for monitoring plants' condition, a foreground object may be determined also based on back and fourth movement such as leaves in the wind. This is while a surveillance system may be configured to ignore such movement and determine foreground objects as those moving in a non periodic oscillatory pattern. Many techniques for extraction of foreground objects are known and may be used in the technique of the present invention as will be further described below.

The objects extracted from the input data, or more specifically, data pieces indicated about the extracted objects, are further processed to determine classes of objects 1030. Each of the extracted objects may generally be processed individually to classify it. The processing may be performed in accordance with invariant properties of the object as detected, generally relating to appearance of the object such as color, size, shape etc. Additionally or alternatively, the processing may be done in accordance with cross image properties of the objects, i.e. properties indicative of temporal variation of the object that require two or more instances in which the same object is identified in different, time separated, frames of the input image stream. Such cross image properties generally include properties such as velocity, acceleration, direction or route of propagation, inter-object interaction etc. It should be noted that generally, not every object has to be classified and in some embodiments the technique relates only to objects identified as being associated with one of a predetermined set of possible types. Objects that are not classified as being associated with any one of the set of predetermined types may be considered as unclassified objects.

The classified objects 1040I to 1040N are collected to provide output data 1060 in the form of a labeled set of objects. More specifically, the output data includes a set of data pieces, where each data piece includes at least data about an object's image and a label indicating the type of object. It should be noted that the data pieces may include additional information such as data about the camera units capturing the relevant scene, lighting conditions, scene data etc.

According to some embodiments, the technique may request, or be configured to allow, manual verification (checkup) of the classified objects 1050. In this connection an operator may review the object data pieces relating to different classes and provide indication for specific object data pieces that are classified to the wrong class. For example, if the system interprets a tree shadow as foreground object and classifies it as a human, the operator may recognize the difference and indicate that the object is miss-classified and should be considered as part of the background or as still object. Generally the technique of the invention may utilize operator correction to improve classification either by utilizing a feedback loop within the initial classification process 1030 or relaying on the fact that the resulting training data set is verified. It should be noted that the manual verification 1050 may be performed on all classified data pieces (objects) or on randomly selected samples.

The output data 1060 is typically configured to be suitable for use as a training data set of a learning machine system. In this connection the output data 1060 generally includes a plurality of data pieces, each corresponding with an object identified in the input data and labeled to specify the class of the object. The number of objects of each label and of the unspecified objects (if used) is preferably sufficient to allow a learning machine algorithm, as known in the art, to determine statistical correlations between image data of the objects and types (and possible additional conditions of the objects) to allow the learning machine system to determine the class/type of object based on unlabeled data piece provided thereto. The learning machine may preferably be able to utilize the training process to be able to determine object's types utilizing invariant object properties indicating object's appearance, while having no or limited information about cross image properties, relating to temporal behavior of the object (e.g. about speed, direction of movements, inter-object interactions etc.).

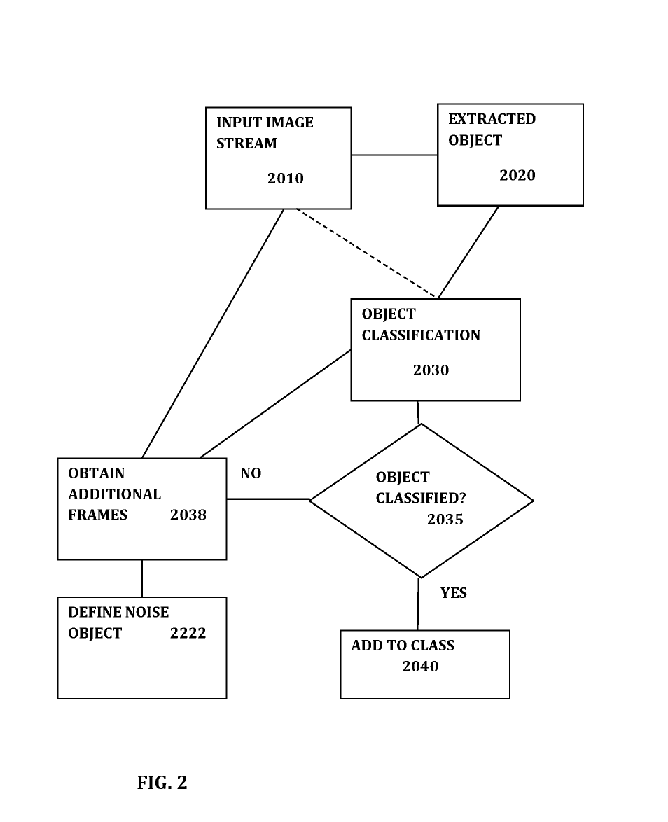

The general process of object classifying is exemplified in FIG. 2 illustrating in a way of a block diagram an exemplary classifying process. Data about foreground objects is extracted 2020 from an input image stream 2010 (which is included in the input data). The extracted object is being classified 2030 in accordance with information extracted with the objects, while additional information from the image stream may be used (shown with dashed arrow). In this connection the objects may be classified based on appearance properties such as relative location to other objects, color, variation of colors, size, geometrical shape, aspect ratio, location etc. For example, the classification may be done by model fitting to the image data of the objects, determining which model type is best fitted to the object. As indicated above, the classifying process may utilize temporal properties, which are generally further extracted from the input image stream. Such temporal properties may include information about objects' speed or velocity, acceleration, movement pattern, interaction with other objects and/or with background of the scene.

Generally, a checkup stage is used to determine if classification is successful 2035, the checkup may be performed manually, by an operator review of the classified object data, but is preferably an automatic process. For example, the classification may be determined based on one or more parameters relating to quality thereof. For example, a quality measure for model fitting or for any other classification method used may provide indication of successful classification or unsuccessful one. If the quality measure exceeds a predetermined threshold the classification is successful and if not it is unsuccessful. Generally, a classification process may provide statistical result indicating probability that the object is a member of each class (e.g. 36% human, 14% dog, 10% tree etc.). A quality measure may be determined in accordance with the maximal determined probability for certain class, and may include a measure of class variation between the most probable class and a second most probable class. The classification is considered successful if the quality measure is above a predetermined threshold and considered unsuccessful (failed) if the quality measure is below the thresholds. Generally the predetermined threshold may include two or more conditions relating to statistical significance of the classification. For example, a classification may be considered successful if the most probable class has 50% probability or more; if the most probable class is determined with less than 50%, the classification may be successful if the difference in probability between the most probable and the second most probable classes is higher than 15%.

If the classification is determined to be unsuccessful, additional data about the extracted object may be required. This relies on the fact the generally extracted objects appear in more than one or two frames in the image stream. Thus, if classification is determined to be unsuccessful, additional instances of the objects in additional frames of the image stream may be used 2038. Such additional instances may provide sharper image or enable to retrieve additional data about the object, as well as enable to improve data about temporal properties and assist in improving classification. In this connection, additional sections of the image stream, typically within certain time boundaries, are processed to identify additional instances of the same object. The data about additional instances may then be used to try classification again 2030 with the improved data.

If the classification is considered unsuccessful (failed) 2035 after a predetermined number of attempts, the extracted object may be considered as noise object 2222. In this connection the term noise object may relate to objects extracted from the input data while not being classified as associated with any of the predetermined objects' classes/types. This may indicate miss extraction of background shapes as foreground objects or, in some cases, actual foreground object that does not fall into any of the predetermined definitions of types. Based on classification preferences, noise objects may take part in the output data set, typically labeled as unclassified objects, or ignore noise objects and remove data about the noise objects from consideration. Also, as shown classified objects are added to the corresponding class 2040 within the labeled data set providing the output data.

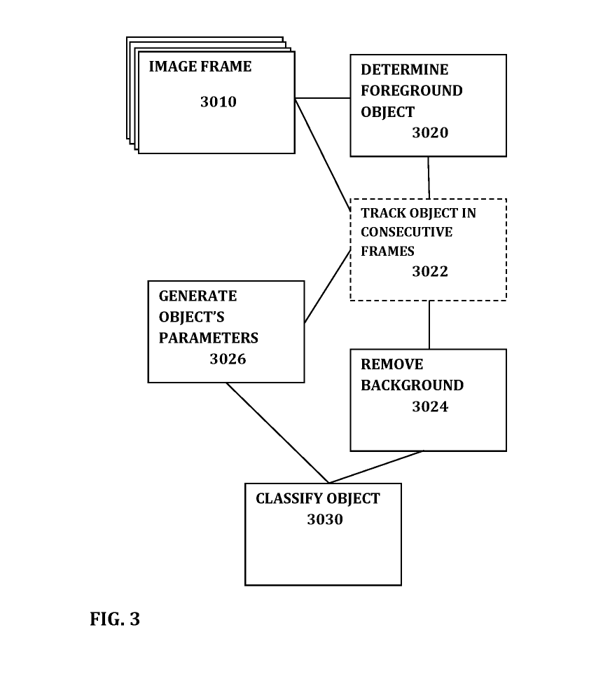

Reference is made to FIG. 3 exemplifying in a way of block diagram several steps of object extractions according to some embodiments of the present invention. As shown, one or more (typically several) image frames 3010 are selected from the input image stream. The selected image frames may be consecutive or within a predetermined (relatively short) time difference between them. One or more foreground objects may be detected within the image frames 3020. The foreground objects may be detected utilizing one or more foreground extraction technique, for example, utilizing image gradient and gradient variation between consecutive frames; determining variation from a prebuilt background model; thresholding differences in pixel values and/or combination of these or additional extraction steps. Detected objects are preferably tracked within several different frames 3022 to optimize object extraction as well as allow extraction of cross image properties and preparation of data enabling to provide additional frames for object classification.

The extracted object is processed to generate parameters 3026 (object related parameters) including appearance/invariant properties as well as temporal properties as described above. The object's parameters are generally used to allow efficient classification of the extracted objects, as well as to allow validation indicating that the extracted data is related to actual objects and not shadows or other variations within the image steam that should be regarded as noise.

Additionally, image data of the extracted object is preferably processed to generate an image data piece relating to the object itself, while not including image data relating to background of the frame 3024. In this connection determining background model and/or image gradients typically enables identifying pixels within one or more specific frames as relating to the extracted foreground object or to the background of the image. It should be noted that providing a data set for training of a machine learning system, while removing irrelevant data from the pieces of the data set may provide more efficient training based on a smaller amount of data. This is as the data pieces of the training data set include only meaningful data such as shape and image data of the labeled object, and do not include background and noise that may provide data with limited or no importance to the learning machine and need to be statistically averaged out to be ignored. Thus, utilizing training data set having objects' image data without the background allows the learning machine utilize smaller data set for training; perform faster training; and reduce wrong identification of objects.

In this connection, it should generally be understood that extraction of one or more foreground objects from an image stream may generally be based on collecting a connected group of pixels within a frame of the image stream. The pixels determined to be associated with the foreground object are considered as foreground pixels while pixels outside the lines defining certain foreground object are typically considered as background related, although may be associated with one or more other foreground objects. In this connection it should be noted that the term surrounding as used herein is to be interpreted broadly as relating to regions or pixels outside the lines defining certain region (e.g. object), while not necessarily being located around the region from all directions.

Classification of the extracted object 3030 may include data about the background, e.g. in the form of location data, background interaction data etc., providing invariant or cross image properties of the object. However, according to some embodiments of the invention, the data piece stored in the output data generally includes image data of the labeled objects while not including data about background pixels of the image.

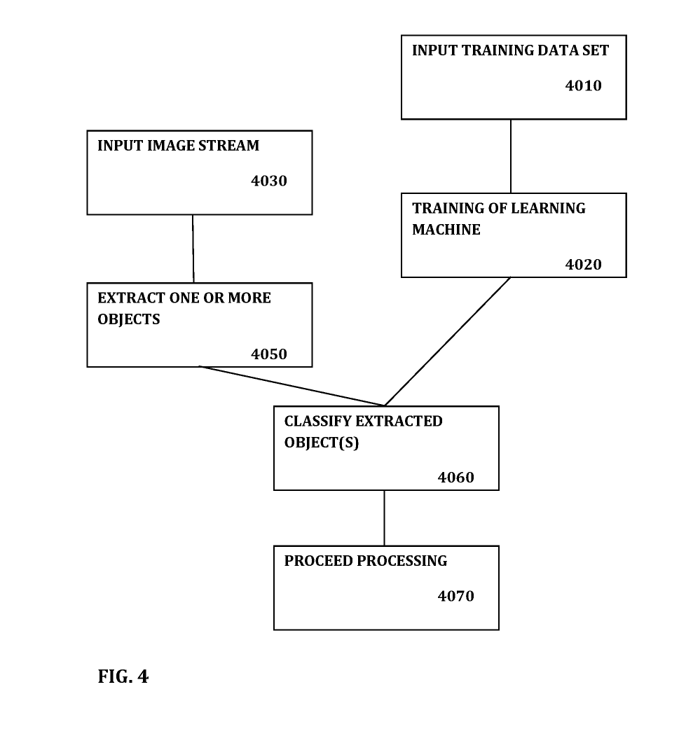

In this connection the technique of the present invention may also be used to provide a learning machine capable of generating a training data set and, after a training period utilizing the training data set, performing object detection and classification in input data/image stream. Reference is made to FIG. 4 illustrating in a way of a block diagram steps of operation of a learning machine according to some embodiments of the invention. FIG. 4 illustrating the operation steps of the learning machine utilizing training data set generated as described above (by the same system or an external system). At a first stage, targets and requirements are generally to be determined for the learning machine; these targets and requirements may also be determined prior to generating of the training data set and affect the types of objects classified, size of the training data set as well as considerations for including noise objects as described above. The training data set is provided to the learning machine 4010, typically in the form of pointer or access to the corresponding storage sectors in a storage unit of the system. However it should be noted that in a distributed system the training data set may be provided through a network communication utility and a local copy may be maintained or not.

Based on the training data set 4010, the learning machine system performs a training process 4020. Generally training of a learning machine is known per se and thus will not be described herein in details, only to note the following. In the training process, the learning machine reviews the data pieces of the training data set to determine statistical correlations and define rules associating the labeled data pieces and the corresponding labels or connection between them. For example, the learning machine may perform training based on a training data set including a plurality of pictures of cats, dogs, humans, cars, horses, motorcycles, bicycles etc. to determine characteristics of objects of each labels such that when an input image data of a cat is provided 4050 for identifying, the trained learning machine can identify 4060 the correct object type.

In this connection, the technique of the invention may also include the learning machine system capable of receiving input data 4030 in the form of an image stream associated with image data from one or more regions of interest. The technique includes utilizing object extraction techniques as described above for extracting one or more foreground objects from the image stream 4050, and performing object identification 4060 based on the training the machine had gone through 4020. In this connection, object extraction by the learning and identification system may utilize determining object related pixels and thus enable identification of the extracted object while ignoring neighbouring background related pixels. This allows the leaning machine (post training) to identify the object based on the object's properties while removing the need to acknowledge background interactions generation noise in the process.

It should be noted that the present technique including preparation of training data set, training of a learning machine based on the prepared training data set and performing object extraction and identification from input image stream may be used for various applications from surveillance, traffic control, storage or shelf stock management, etc. In this connection, the learning machine system may provide indications about type of extracted objects to determine if location and timing of object detection correspond to expected values or require any type of further processing 4070.

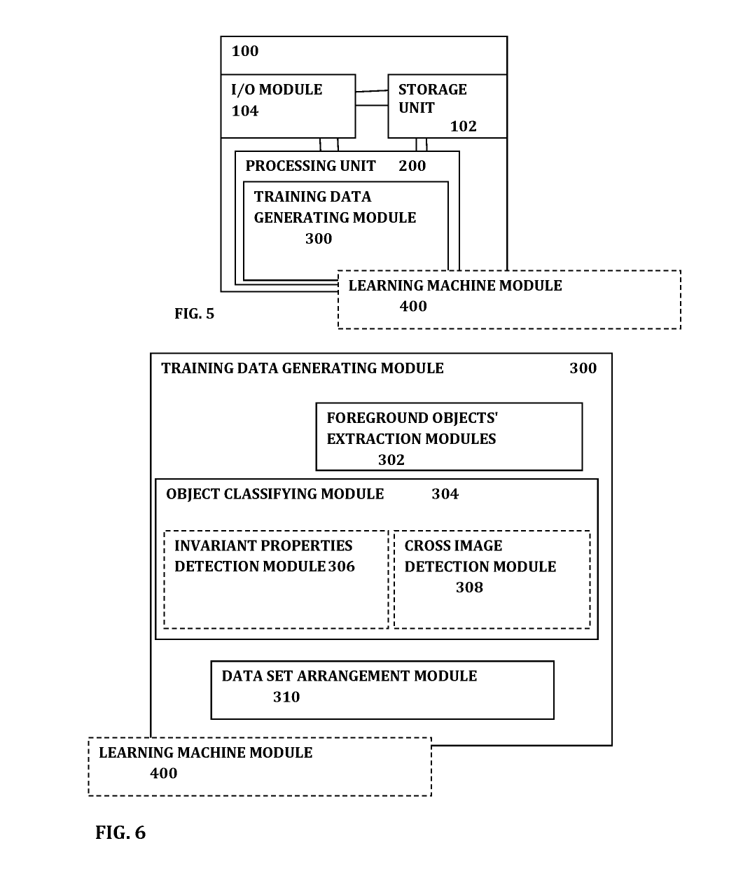

As indicated above, the present technique is generally performed by a computer system. In this connection, reference is made to FIG. 5 and FIG. 6 schematically illustrating a computerized system 100 configured and operable to perform the technique of the invention. As shown in FIG. 5, the system 100 generally includes an input and output I/O module 104, e.g. including network communication interface, manual input and output such as keyboard and/or screen, etc.; at least one storage unit 102, which may be local or remote or include both local and remote storage; and at least one processing unit 200. It should be noted that generally the processing unit may be a local processor or utilize distributed processing by a plurality of processors communicating between them via network communication. The processing unit includes one or more hardware or software modules configured to perform desired tasks; a training data generation module 300 is exemplified in FIG. 5.

In this connection, the system 100 is configured and operable to perform the above described technique to thereby generate a desired training data set of use in training of machine learning systems. More specifically, the system 100 is configured and operable to receive input data, e.g. including one or more image streams generated by one or more camera units and being indicative of one or more regions of interest, and process the input data to extract foreground objects therefrom, classify the extracted objects and generate accordingly output data including a labeled set of data pieces suitable for training of a learning machine system. Typically, the processing unit 200 and the training data generation module 300 thereof are configured to extract data pieces indicative of foreground objects from the input data, classify the extracted objects and generate the labeled data set. This is while the resulting training data set and intermediate data pieces are generally stored within dedicated sectors of the storage unit. As also shown in the figure, the system 100 may include a learning machine module 400 configured to utilize the training data set for generating required processing abilities and perform required tasks including identification of extracted data pieces as described above.

Reference is now made to FIG. 6 illustrating configuration of the data generation module 300 in more details. More specifically, the data generation module 300 may generally include a foreground objects' extraction module 302, Object classification module 304, and a Data set arrangement module 310. The foreground objects' extraction module is configured and operable to receive input image data indicative of a set of consecutive frames selected from the input data, and identify within the image data one or more foreground objects. As described above, the definition of a foreground object may be determined in accordance with operational targets of the system. More specifically, as described above, a tree moving in the wind may be considered as background for traffic management applications, but may be considered as foreground object by systems targeted at agriculture or weather forecast applications. As described above, the foreground objects' extraction module 302 may utilize one or more foreground objects extraction methods including, but not limited to, comparison to background model, image gradient, thresholding, movement detection etc. Image data and selected properties associated with objects extracted from the input image stream are temporarily stored within the storage unit 102 for later use, and may also be permanently stored for backup and quality control. The foreground objects' extraction module 302 may generally transmit data about extracted objects (e.g. pointer to corresponding storage sectors) to the object classifying module 304 indicating objects to be further processed.

The Object classification module 304 is configured and operable to receive data about extracted foreground objects and determine if the object can be classified as belonging to one or more object types. The Object classification module 304 may typically utilize one or more of invariant object properties, processed by the invariant object properties module 306, and/or one or more cross image object properties, typically processed by the cross image detection module 308. In this connection the extracted object may be classified utilizing one or more classification techniques as known in the art, including fitting of one or more predetermined models, comparing properties such as size, shape, color, color variation, aspect ratio, location with respect to specific patterns in the frame, speed or velocity, acceleration, movement pattern, inter object and background interactions etc.

In this connection, and as indicated above, the object classification module 304 may utilize image data of one or more frames to generate sufficient data for classifying of the object. Additionally, the object classification module 304 may request access to storage location of additional frames including the corresponding object to determine additional object properties and/or improve data about the object. This may include data about longer propagation path, additional interactions, image data of the object from additional points of view or additional faces of the object etc. Generally the object classification module 304 may operate as described above, with reference to FIG. 2 to determine type of extracted objects and generate corresponding labeled to be stored together with the object data in the storage unit 102. Additionally, the object classification module 304 may generate an indication to be stored in an operation log file, indicating that a specific object has been classified, type of the object and an indication of storage sector storing the relevant data.

When a sufficient volume (amount) of extracted objects have been classified, the data set arrangement module 310 may receive indication to review and process the operation log file and prepare a training data set based on the classified objects. In this connection the data arrangement module 310 may be configured and operable to prepare a data set including image data of the classified objects (typically not including background pixel data) with labels indicating the type of object in the image data. Although additional information about the objects may exist being stored in the storage unit 102, this additional data is preferably not a part of the training data set to provide the learning machine with the ability to identify extracted objects based on image data not needing additional information.

It should be noted, and as indicated above, that the system 100 and the data generation module 300 thereof, may include, or be associated with a learning machine system 400. As described with reference to FIG. 4, the learning machine system is typically configured to perform training based on the training data set generated by the data generation module 300, and utilize the training to identify additional objects, which may be extracted from further image streams and/or provided thereto from any other source. As indicated, the learning machine system 400 may be configured to provide appropriate indication in the case one or more conditions are identified, including location of specific object types in certain location, number of objects in certain locations etc.

In this connection, the technique of the present invention provides for automatic generating of training data set from input image stream. The technique of the invention provides a generally unsupervised process, however, it should be noted that in some embodiments the technique of the invention may utilize manual quality control including review of the generated training data set to ensure proper labeling of objects etc. It should also be noted that the use of automatic preparation of training data set may allow the use of smaller training data set providing for faster training sessions while not limiting the learning machine operation. Those skilled in the art will readily appreciate that various modifications and changes can be applied to the embodiments of the invention as hereinbefore described without departing from its scope defined in and by the appended claims.

1. A computer-implemented method of classifying objects from a stream of images, comprising:
providing input data comprising data indicative of at least one image stream;
processing said input data and extracting from said at least one image stream a plurality of foreground objects;
classifying said plurality of objects, said classifying comprising associating at least some of said plurality of objects in accordance with at least one object type, thereby generating at least one group of objects of similar object types; and
generating a training database comprising a plurality of data pieces/records, each data piece comprising image data of one of said plurality of foreground objects and a corresponding objects type, said training database being configured for use in training of a learning machine system.

2. The method of claim 1, wherein said classifying comprising: providing a selected foreground object extracted from said at least one image stream and processing said selected object to determine a corresponding object type, said processing comprises determining at least one appearance property of the object from at least one image of said stream and at least one temporal property of the object from at least two images of said stream.

3. The method of claim 2, wherein said at least one appearance property of the object comprises at least one of the following: size, geometrical shape, aspect ratio, color variance and location.

4. The method of claim 2, wherein said at least one temporal property comprises at least one of the following: speed, acceleration, direction of propagation, linearity of propagation path and inter-objects interactions.

5. The method of claim 1, wherein said extracting from said at least one image stream a plurality of foreground objects comprising determining within corresponding image data of said at least one image stream a group of connected pixels associated with a foreground object and separated at least partially from surrounding pixels associated with background of said image data.

6. The method of claim 1, wherein said generating a training database comprising dedicating a group of memory storage sections, each associated with an identified objects type and storing data pieces of said plurality of classified foreground objects in memory storage sections corresponding to the assigned object types thereof.

7. The method of claim 1, wherein said data pieces comprising image data of one of said plurality of foreground objects are characterized as consisting of pixel data corresponding to detected foreground pixels while not including pixel data corresponding to background of said image data.

8. A method of classifying one or more objects extracted from image stream, the method comprising:
(a) providing a training data set, the training data set comprising a plurality of classified objects, each classified objects consists of pixel data corresponding to foreground of said image stream;
(b) training a learning machine system based on said data set to statistically identify foreground objects as relating to one or more objects types;
(c) providing an image stream comprising data about one or more foreground objects, extracting at least one of said one or more foreground objects to be classified from said training, said at least one foreground objects to be classified consists of image data corresponding to foreground related pixels; and
(d) classifying said at least one foreground objects using said learning machine system in accordance with said training data set.

9. The method of claim 8, wherein said providing of a training data set comprises:
providing input data comprising data indicative of at least one image stream;
processing said input data and extracting from said at least one image stream a plurality of foreground objects;
classifying said plurality of objects, said classifying comprising associating at least some of said plurality of objects in accordance with at least one object type, thereby generating at least one group of objects of similar object types; and
generating a training database comprising a plurality of data pieces/records, each data piece comprising image data of one of said plurality of foreground objects and a corresponding objects type, said training database being configured for use in training of a learning machine system.

10. The method of claim 8, comprising inspecting the training data set by a user before the training of the learning machine system, identifying misclassified objects, and correcting classification of said misclassified objects or removing them from said training set.

11. A system comprising: at least one storage unit, input and output modules and at least one processing unit, said at least one processing unit comprising a training data generating module configured and operable for receiving data about at least one image stream and generating at least one training data set comprising a plurality of classified objects, each of said classified objects consisting of image data corresponding to foreground related pixel data.

12. The system of claim 11, wherein said a training data generating module comprises:
(a) foreground objects' extraction modules configured and operable for processing input data comprising at least one image stream for extracting a plurality of data pieces corresponding to a plurality of foreground objects of said at least one image stream, each of said data pieces consist of pixel data corresponding to foreground related pixels;
(b) object classifying module configured and operable for processing at least one of said plurality of data pieces to thereby determine at least one of appearance and temporal properties of the corresponding foreground object to thereby classify said foreground objects as relating to at least one object type; and
(c) data set arranging module configured and operable for receiving a plurality of classified data pieces and for dedicating memory storage sections in accordance with the corresponding object types and storing said data pieces accordingly to thereby generate a classified data set for training of a learning machine.

13. The system of claim 12, wherein said object classifying module further comprising an appearance properties detection module configured and operable for receiving image data corresponding to an extracted foreground object and determining at least one appearance property thereof, said at least one appearance property comprises at least one of: size, geometrical shape, aspect ratio, color variance and location.

14. The system of claim 12, wherein said object classifying module further comprising a cross image detection module configured and operable for receiving image data associated with data about a foreground object extracted from at least two time separated frames, and determining accordingly at least one temporal property of said extracted foreground object, said at least one cross image property comprises at least one of the following: speed, acceleration, direction of propagation, linearity of propagation path and inter-objects interactions.

15. The system of claim 11, wherein said processing unit further comprises a learning machine module configure for receiving a training data set from said training data generating module and for training to identify input data in accordance with said training data set.

16. The system of claim 15, wherein said learning machine module further configured and operable for receiving input data and for classifying said input data as belonging to at least one data type in accordance with said training of the learning machine module.

17. The system of claim 15, wherein said input data comprises data about at least one foreground object extracted from at least one image stream.

18. The system of claim 17, wherein said data about at least one foreground object consists of foreground related pixel data.
